(19) United States
(12) Patent Application Publication
(10) Pub. No.: US 2015/0160007 A1
(43) Pub. Date: Jun. 11, 2015

(54) LASER TRANSMITTING CIRCUIT, LASER RECEIVING CIRCUIT, DISTANCE CALCULATION CIRCUIT AND DEVICES THEREOF

(71) Applicant: CHONGQING AITE OPTICAL AND ELECTRONICS CO., LTD., Chongqing (CN)

(72) Inventors: RiXin XU, Chongqing (CN); Shunde WANG, Chongqing (CN)

(73) Assignee: CHONGQING AITE OPTICAL AND ELECTRONICS CO., LTD., Chongqing (CN)

(21) Appl. No.: 14/141,690

(22) Filed: Dec. 27, 2013

(30) Foreign Application Priority Data
Dec. 11, 2013 (CN) 2013106741050

(51) Int. Cl. G01C 3/08; G01S 7/484; G01S 17/08

(52) U.S. Cl. CPC G01C 3/08; G01S 17/08; G01S 7/484

(57) ABSTRACT

The present invention provides a laser transmitting circuit, a laser receiving circuit, a distance calculation circuit and devices thereof. The laser transmitting circuit comprises an energy storage capacitor, a laser transmitting tube, an MOS switch circuit and an MOS switch driving circuit. The laser receiving circuit comprises a laser receiving tube, a first low-noise triode, a second low-noise triode and a low-noise wideband amplifier. The distance calculation circuit comprises a singlechip, a programmable logic circuit, a clock source and an echo identification circuit. The present invention further provides a low-voltage power circuit that provides a reverse polarity protection to an external power supply without additional diode connected in reverse polarity. According to the technical solutions provided by the present invention, the measurement range and precision of a semiconductor laser rangefinder can be improved effectively.

### TECHNICAL FIELD

The present invention relates to the field of laser distance measurement, particularly to a laser transmitting circuit, a laser receiving circuit, a distance calculation circuit and devices thereof.

### BACKGROUND ART

As an instrument for accurately measuring the distance of a target via laser, a laser rangefinder transmits an elliptical, conical laser beam to a target during working. The laser reflected by the target is received by a photoelectric element. A timer measures the time taken from initial transmission to final reception of the laser beam, so that the distance from the observer to the target is calculated. Semiconductor laser rangefinders have advantages of low weight, small size, low power consumption and simple operation. For a semiconductor laser rangefinder in the prior art, its electronic circuitry also includes a laser transmitting circuit, a laser receiving circuit and a mainboard circuit for calculating distance.

In a laser transmitting circuit in the prior art, a switch circuit mainly consists of two avalanche transistors. As the time required to turn on or off the avalanche transistors is relatively long and the peak pulse current (Ip=10 A) is relatively small, the pulse current provided for a laser transmitting tube is reduced and the peak power of laser transmitted by the laser transmitting tube cannot reach its rated value, so that the laser transmitting tube is underutilized. As a result, the distance measurement capability of a semiconductor laser rangefinder is weakened.

A laser receiving circuit in the prior art generally comprises two-staged amplification implemented by a pre-amplifier and a post-amplifier which consist of four triodes. As the post-amplifier has a relatively low amplification factor and is inconvenient in adjustment, the measurement range of a semiconductor laser rangefinder, particularly a semiconductor laser rangefinder using PIN photodiodes, is reduced.

The principle of a circuit for calculating distance in the prior art is time interval stretching. The circuit has the following major elements: a singlechip, a trigger, an MOS field effect transistor, a timing capacitor, a switch triode and the like. Such circuit has the disadvantage that the requirements on the timing capacitor used for charging or discharging are strict as it is required to have low current leakage and good temperature stability. In addition, due to poor linear charging and discharging of the capacitor, the difference between the distance measurement errors of different distance sections is considerable, so it is required to perform error calibration to multiple distance sections.

Therefore, it is necessary to provide effective technical solutions to improve the measurement range and precision of a semiconductor laser rangefinder and to simplify the steps for error calibration of distance measurement.

### SUMMARY OF THE INVENTION

An object of the present invention is to at least solve one of the above technical defects, particularly to solve the problems of short measurement range and complicated steps for error calibration of distance measurement of a semiconductor laser rangefinder in the prior art.

To achieve the above object, one aspect of the present invention provides a laser transmitting circuit, comprising an energy storage capacitor, a laser transmitting tube, an MOS switch circuit and an MOS switch driving circuit,

a low-potential end of the energy storage capacitor is connected to a cathode of the laser transmitting tube, while a high-potential end of the energy storage capacitor is connected to a drain of the MOS switch circuit;
a grounding end of the MOS switch circuit is connected to an anode of the laser transmitting tube; and
an output end of the MOS switch driving circuit is connected to an input end of the MOS switch circuit.

Another aspect of the present invention further provides a laser receiving circuit, comprising a laser receiving tube, a first low-noise triode, a second low-noise triode and a low-noise wideband amplifier,

an anode of the laser receiving tube is connected to a base of the first low-noise triode;
an emitter of the first low-noise triode is connected to a base of the second low-noise triode;
a collector of the second low-noise triode is connected to an input end of the low-noise wideband amplifier via a capacitor; and
when the laser receiving tube receives echo laser, the echo laser is converted into electric pulse; and the electric pulse in turn passes through a pre-amplifier consisting of the first low-noise triode and the second low-noise triode, and then a post-amplifier of the low-noise wideband amplifier, to generate and output an echo signal.

Still another aspect of the present invention further provides a circuit for calculating distance, comprising a singlechip, a programmable logic circuit, a clock source and an echo identification circuit, wherein an output end of the echo identification circuit is connected to an input end of the programmable logic circuit, an output end of the clock source is connected to an input end of the programmable logic circuit, and an output end of the programmable logic circuit is connected to an input end of the singlechip;

the echo identification circuit is configured to identify a signal from the laser receiving circuit including target echo signal and noise, and to realize echo detection within a minimum distance not longer than 5 m by controlling a threshold of the echo identification circuit;
the programmable logic circuit is configured to receive an echo pulse and perform a time measurement to the echo pulse according to a signal from the clock source; and
the singlechip is configured to control the programmable logic circuit and calculate a distance from a target according to information about the time measurement provided by the programmable logic circuit.

Yet another aspect of the present invention further provides a semiconductor laser rangefinder, comprising devices of any one of the above circuits.

In the technical solutions provided by the present invention, the laser transmitting circuit allows taking full advantageous of the laser transmitting tube so that the laser transmission power is improved and the measurement range of the rangefinder is increased. In addition, in the technical solutions provided by the present invention, the laser receiving circuit improves the capability of amplifying weak echo signals and is convenient in debugging. Furthermore, the mainboard circuit for calculating distance provided by the present invention may improve the distance measurement precision and simplify the steps for error calibration of distance measurement.

Additional aspects and advantages of the present invention will be provided in part in the following descriptions, become apparent from the following descriptions or be learned by the practice of the present invention.

### BRIEF DESCRIPTION OF THE DRAWINGS

These and/or further aspects and advantages of the present invention will become apparent and be more readily appreciated from the following descriptions taken with reference to the drawings. In the drawings:

FIG. 1 is a block diagram for the overall principle of circuits of a semiconductor laser rangefinder according to the present invention;

FIG. 2 is a functional schematic diagram of a laser transmitting circuit of a semiconductor laser rangefinder according to embodiments of the present invention;

FIG. 3 is an electrical schematic diagram of a laser transmitting circuit of a semiconductor laser rangefinder according to embodiments of the present invention;

FIG. 4 is a functional schematic diagram of a laser receiving circuit of a semiconductor laser rangefinder according to embodiments of the present invention;

FIG. 5 is an electrical schematic diagram of a laser receiving circuit of a semiconductor laser rangefinder according to the present invention;

FIG. 6 is a functional schematic diagram of a circuit for calculating distance of a semiconductor laser rangefinder according to embodiments of the present invention;

FIG. 7 is an electrical schematic diagram of a circuit for calculating distance of a semiconductor laser rangefinder according to the present invention;

FIG. 8 is an electrical schematic diagram of a target echo identification circuit of a semiconductor laser rangefinder according to the present invention; and,

FIG. 9 is an electrical schematic diagram of a low-voltage power circuit of a semiconductor laser rangefinder according to the present invention.

### DETAILED DESCRIPTION OF THE INVENTION

Embodiments of the present invention will be described in detail as below. The examples of the embodiments will be illustrated by the accompanying drawings in which same or similar reference numbers represent same or similar elements or elements with same or similar functions. The embodiments described as below with reference to the drawings are exemplary only for explaining the present invention and shall not be interpreted as any limitation to the present invention.

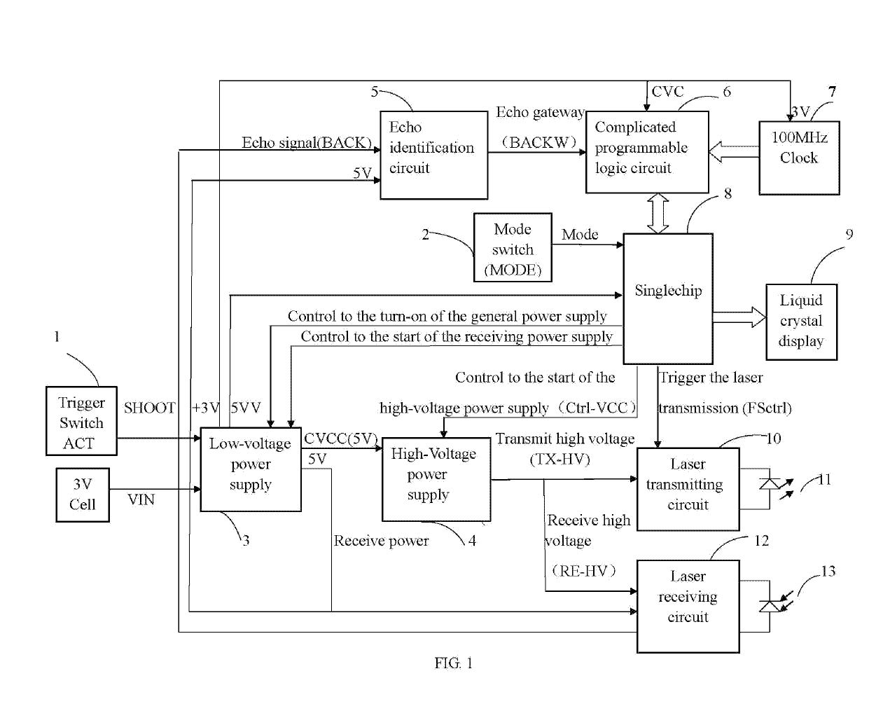

As shown in FIG. 1 is a block diagram for the overall principle of circuits of a semiconductor laser rangefinder according to the present invention, in which: 1—Trigger switch; 2—Mode switch; 3—Low-voltage power supply; 4—High-voltage power supply; 5—Echo identification circuit; 6—Programmable logic circuit; 7—Clock source; 8—Singlechip; 9—Liquid crystal display; 10—Laser transmitting circuit; 11—Laser transmitting tube; 12—Laser receiving circuit; and, 13—Laser receiving tube.

In FIG. 1, as an embodiment of the present invention, the laser transmitting circuit 10 and the laser transmitting tube 11 are mounted on a laser transmitting circuit board. The laser receiving circuit 12 and the laser receiving tube 13 are mounted on a laser receiving circuit board. All other circuits 1-8 are mounted on a main circuit board. The liquid crystal display 9 is mounted in an eyepiece of a rangefinder. A cell of 3V outputs three groups of 5V power through two pieces of DC-DC boost converters in the low-voltage power circuit 3. The first group (CVCC-5V) is supplied to the high-voltage power circuit 4, the second group (5V) is supplied to the laser receiving circuit 12 and the echo identification circuit 5, and the third group (5VV) is supplied to the singlechip 8; then the three groups output 3V to the programmable logic circuit 6 and the clock source 7 via a three-terminal regulator.

The trigger switch 1 is pressed down for distance measurement, while the mode switch 2 is pressed down for mode conversion. All instructions about the time for timed turn-on of the general power supply, the turn-on of the receiving power supply, the operation of the high-voltage power supply and the starting time for transmitting the laser are sent by the singlechip, respectively. When the voltage of the cell drops to a predetermined value, the singlechip gives a signal to enable the liquid crystal display 9 to display a symbol indicating the cell is under-voltage, in order to give a prompt for cell replacement.

A driving signal output by the singlechip is connected to the liquid crystal display via a socket 45. The laser transmitting circuit board is connected to the main circuit board via a socket 46. The laser receiving circuit board is connected to the main circuit board via sockets 47 and 48.

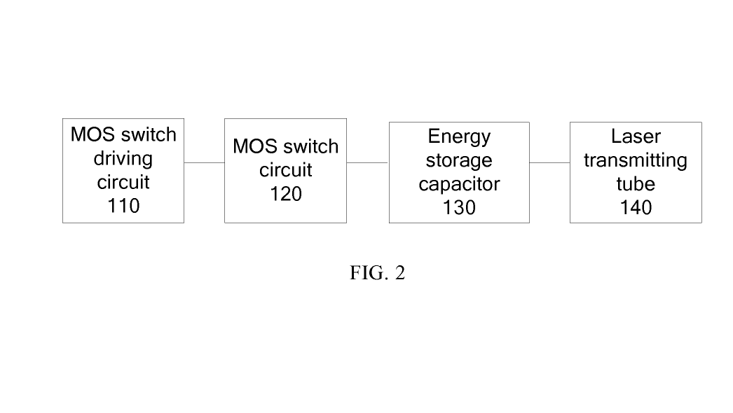

As shown in FIG. 2 is a functional schematic diagram of a laser transmitting circuit of a semiconductor laser rangefinder according to embodiments of the present invention, in which: 110—MOS switch driving circuit; 120—MOS switch circuit; 130—Energy storage capacitor; and, 140—Laser transmitting tube.

Specifically, the low-potential end of the energy storage capacitor 130 is connected to the cathode of the laser transmitting tube 140, while the high-potential end of the energy storage capacitor 130 is connected to the drain of the MOS switch circuit 120; the grounding end of the MOS switch circuit 120 is connected to the anode of the laser transmitting tube 140; and, the output end of the MOS switch driving circuit 110 is connected to the input end of the MOS switch circuit 120.

The MOS switch driving circuit 110 controls the MOS switch circuit 120 by the following steps: the MOS switch circuit 120 is turned on when the MOS switch driving circuit 110 is triggered, so that the energy storage capacitor 130 discharges to the laser transmitting tube 140 to make the laser transmitting tube 140 generate pulse laser; or, the MOS switch circuit 120 is turned off when the MOS switch driving circuit 110 has no output, so that a high-voltage power supply charges the energy storage capacitor 130 to get ready for the next laser transmission.

As an embodiment of the prevent invention, the time for turning on or off the MOS switch circuit 120 meets the following conditions:

turn-on time ton≦10 ns, and turn-off time toff≦22 ns.

As an embodiment of the prevent invention, the pulse current of the MOS switch circuit 120 meets the following condition:

pulse current Ip≦100 A.

Usually, the turn-on time ton and the turn-off time toff of an avalanche transistor will be relatively long, for example, ton=50-110 ns and toff=460-1650 ns; and the peak pulse current generated by the avalanche transistor will correspondingly be relatively small, for example, Ip=10 A. Therefore, the pulse current provided for the laser transmitting tube is reduced and the peak power of laser transmitted by the laser transmitting tube cannot reach its rated value, so that the laser transmitting tube is underutilized. As a result, the distance measurement capability is weakened.

The laser transmitting circuit provided by the present invention employs a high-speed CMOS integrated circuit, for example, BSC600N25, as a discharge switch, thus the turn-on or turn-off time of the MOS switch circuit 120 meets the following conditions: the turn-on time ton≦10 ns, and the turn-off time toff≦22 ns. For example, as an embodiment of the present invention, the turn-on time ton and the turn-off time toff are far less than those of avalanche transistors used in the exiting circuits. The pulse current of the MOS switch circuit 120 is as follows: Ip=100 A, which is much larger than the pulse current of the avalanche transistors used in the exiting circuits, thus providing larger peak current for the transmitting tube, ensuring that the peak power of laser reaches the rated value, and taking full advantageous of the laser transmitting tube 140. Correspondingly, the distance measurement capability is improved.

Therefore, the MOS switch circuit 120 has short on-off time and large pulse current, which increases the pulse current passing through the laser transmitting tube 140 and hence strengthens the pulse laser generated by the laser transmitting tube 140, so that the measurement range of the semiconductor laser rangefinder reaches 2 Km or even farther.

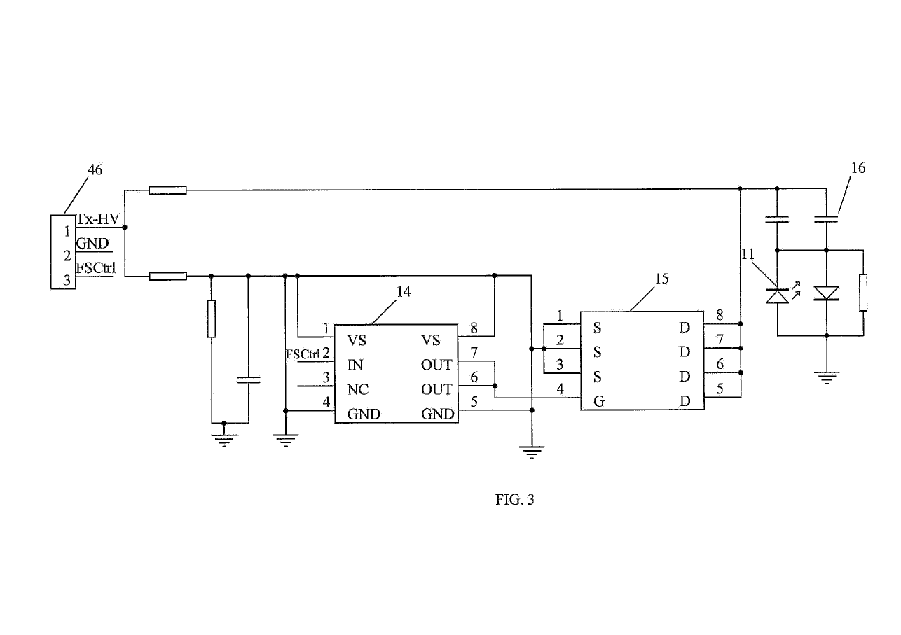

As shown in FIG. 3 is an electrical schematic diagram of a laser transmitting circuit of a semiconductor laser rangefinder according to the present invention, in which: 11—Laser transmitting tube; 14—MOS switch driving circuit; 15—MOS switch circuit; 16—Energy storage capacitor; and, 46—Socket.

As an embodiment of the present invention, the laser transmitting circuit of the present invention employs a high-speed CMOS integrated circuits as a discharge switch, wherein the turn-on time ton and the turn-off time toff (ton=10 ns and toff=22 ns) are much shorter than those of the avalanche transistors used in the existing circuits, and the pulse current (Ip=100 A) is much larger than that of the avalanche transistors used in the existing circuits, thus providing larger peak current for the transmitting tube, ensuring that the peak power of laser reaches the rated value, and taking full advantageous of the laser transmitting tube. The short on-off time and large pulse current of the MOS switch circuit 120 increases the pulse current passing through the laser transmitting tube 140, so the pulse laser generated by the laser transmitting tube 140 is strengthened, so that the measurement range of the semiconductor laser rangefinder reaches 2 Km or even farther.

In FIG. 3, the energy storage capacitor 16 provides input energy for the laser transmitting tube 11. When the MOS switch circuit 15 is turned on, the energy storage capacitor 16 discharges to the laser transmitting tube 11, so that pulse current in dozens of amperes passes through the laser transmitting tube 11 to enable the laser transmitting tube to generate pulse laser in dozens of Watts. A signal (FSctrl) to trigger the MOS switch driving circuit 14 is sent by the programmable logic circuit 6 of the main circuit board, and this trigger signal simultaneously serves as a start signal for a time measurement of the distance measurement. The voltage for charging the energy storage capacitor 16 is supplied by a high-voltage power supply TX-HV, and this voltage is about 120V. When the MOS switch circuit 15 is turned off, the energy storage capacitor 16 is charged. The high-voltage input power and the trigger signal of this circuit are connected to the main circuit board via the socket 46.

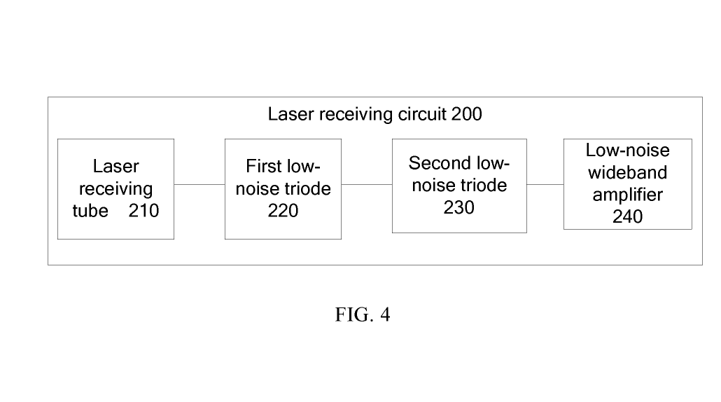

FIG. 4 is a functional schematic diagram of a laser receiving circuit of a semiconductor laser rangefinder according to embodiments of the present invention, in which: 210-Laser receiving tube; 220-First low-noise triode; 230-Second low-noise triode; and, 240-Low-noise wideband amplifier. The anode of the laser receiving tube 210 is connected to the base of the first low-noise triode 220. The emitter of the first low-noise triode 220 is connected to the base of the second low-noise triode 230. The collector of the second low-noise triode 230 is connected to the input end of the low-noise wideband amplifier 240 via a capacitor. When the laser receiving tube 210 receives echo laser, the echo laser is converted into electric pulse. The electric pulse in turn passes through a pre-amplifier consisting of the first low-noise triode 220 and the second low-noise triode 230 and then a post-amplifier of the low-noise wideband amplifier 240 to generate and output an echo signal.

The input end of the laser receiving tube 210 is connected to a high-voltage power supply unit. This high-voltage power supply serves to provide the operating bias voltage for the laser receiving tube 210. The power of the first low-noise triode 220, the second low-noise triode 230 and the low-noise wideband amplifier 240 is supplied by a low-voltage power supply unit.

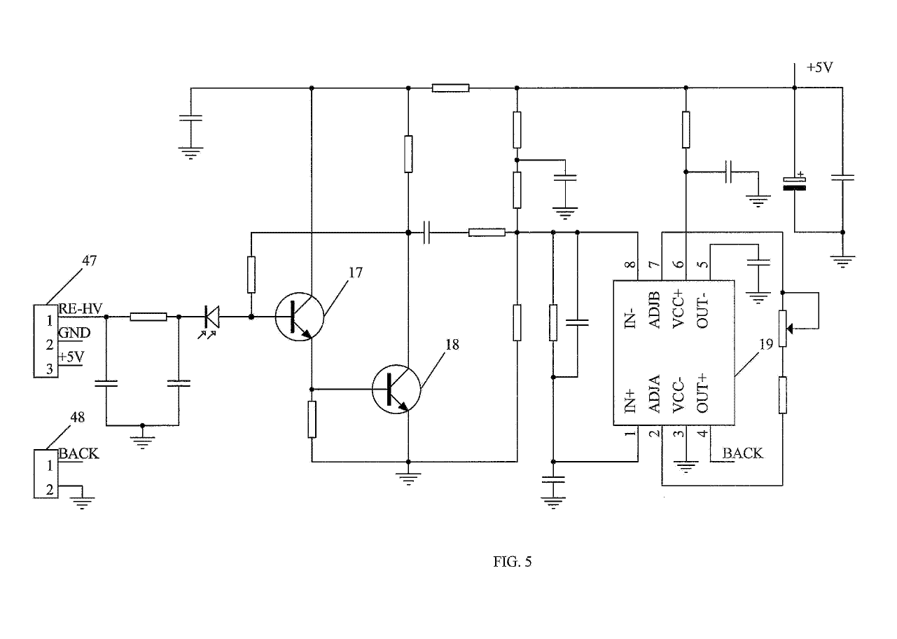

As shown in FIG. 5 is an electrical schematic diagram of a laser receiving circuit of a semiconductor laser rangefinder according to the present invention, in which: 17—First low-noise triode; 18—Second low-noise triode; 19—Low-noise wideband amplifier; 47—Socket; and, 48—Socket.

The laser receiving circuit provided by the present invention employs two low-noise NPN triodes as a pre-amplifier. That is, the pre-amplifier consisting of the first low-noise triode and the second low-noise triode has a higher signal-noise ratio and good impedance matching with the laser receiving tube. With a voltage amplification factor that is adjustable from 0 to 400 times and a bandwidth that reaches 50 MHz, the low-noise, wideband, post-amplifier has a rapid frequency response to the echo pulse and is applicable to laser rangefinders with higher measurement precision (for example, 0.1 m). The laser receiving circuit provided by the present invention may provide a higher amplification factor, and may strengthen the amplification capability to a weak signal. The whole receiving circuit has the advantages of high signal-noise ratio, wide frequency band, and strong capability of receiving weak echo signals. When an avalanche photodiode with internal gain is applied in the receiving tube, the measurement range of the semiconductor laser rangefinder may reach 2 Km or even farther. When a PIN photodiode without internal gain is applied, a high receiving sensitivity may be realized, and the measurement capability of the semiconductor laser rangefinder may be improved. The PIN photodiode has obvious advantages that it is less expensive and the bias supply is simple.

In FIG. 5, the operating voltage of the laser receiving tube 13 is supplied by a power supply RE-HV, and the operating voltage of the echo signal amplification circuit is supplied by a power supply of +5V. When receiving a laser echo reflected by a target, the laser receiving tube converts the optical signal into weak electric pulse. The electric pulse in turn passes through a pre-amplifier consisting of the first low-noise triode 17 and the second low-noise triode 18 for pre-staged amplification, and then a post-amplifier of the low-noise wideband amplifier 19 for post-staged amplification, subsequently outputs and sends an echo signal (BACK) to the target echo identification circuit. The 5V power supply of the laser receiving circuit is controlled by an output SVC of the singlechip. The high-voltage input power and the 5V power of this circuit are connected to the main circuit board via the socket 47, and the output echo signal is connected to the main circuit board via the socket 48.

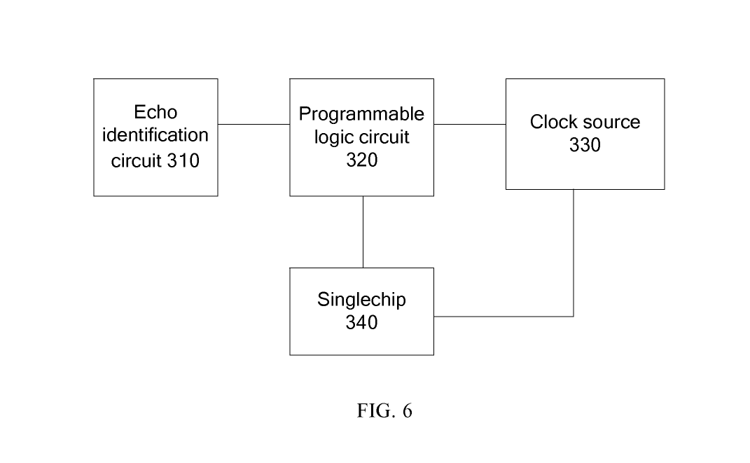

FIG. 6 shows a functional schematic diagram of a circuit for calculating distance of a semiconductor laser rangefinder according to embodiments of the present invention, in which: 310—Echo identification circuit; 320—Programmable logic circuit; 330—Clock source; and, 340—Singlechip. The output end of the echo identification circuit is connected to the input end of the programmable logic circuit. The output end of the clock source is connected to the input end of the programmable logic circuit. The output end of the programmable logic circuit is connected to the input end of the singlechip. The echo identification circuit is configured to identify a signal from a laser receiving circuit including a target echo signal and noise, and output an echo pulse after identification. The programmable logic circuit is configured to receive the echo pulse and perform a time measurement to the echo pulse according to a signal from the clock source. The singlechip is configured to control the programmable logic circuit, calculate the distance from a target according to information about the time measurement provided by the programmable logic circuit, and drive the display. The clock source is a 100 MHz quartz crystal oscillator. As the 100 MHz quartz crystal has high stability for clock frequency, the generated errors in distance measurement are small, so that the calibration steps of the distance errors are simplified.

As an embodiment of the present invention, in the singlechip, sixteen output ends are connected to an LCD display, three input ends are connected to three output ends of the programmable logic circuit, one input end is connected to the mode switch, one input end is connected to the trigger switch, two output ends are connected to the control end of the low-voltage power supply, and two output ends are connected to the target echo identification circuit. In the programmable logic circuit, one input end is connected to the clock source, three output ends are connected to three input ends of the singlechip, one output end is connected to the transmitting circuit, two output ends are connected to the control end of the high-voltage power supply, and one input end is connected to the output end of the target echo identification circuit.

As an embodiment of the present invention, the mainboard circuit for calculating distance in the semiconductor laser rangefinder further comprises:

a low-voltage power supply unit and a high-voltage power supply unit, which supply power to the laser transmitting circuit, the laser receiving circuit and other circuits on the mainboard, respectively.

The mainboard circuit for calculating distance in the semiconductor laser rangefinder is also controlled by the trigger switch and the mode switch. The trigger switch is configured to control the distance measurement, and the mode switch is configured to perform switchover of the measurement unit (meter or yard) and the measurement function.

The mainboard circuit for calculating distance in the semiconductor laser rangefinder further comprises:

a cell-voltage sampler and divider for monitoring the service condition of the cell.

The low-voltage power circuit has a function of reverse polarity protection for the cell. If the cell is connected in reverse polarity, the display will not be lighted when the trigger switch is pressed down; furthermore, in this case, the cell is in an open state, so that there is no damage to the cell.

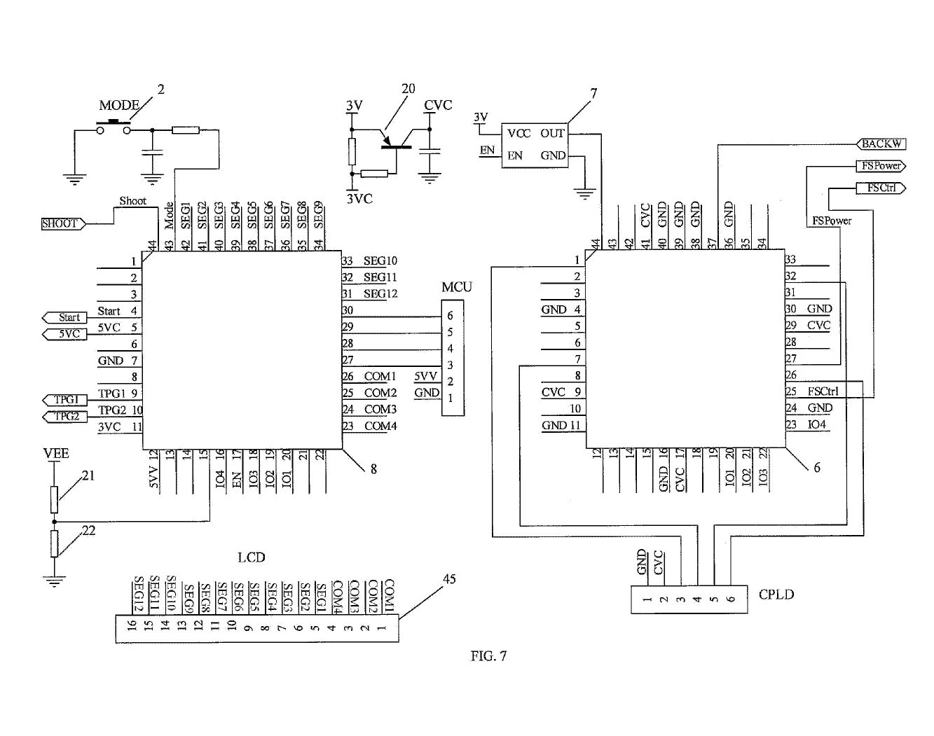

FIG. 7 shows an electrical schematic diagram of a circuit for calculating distance of a semiconductor laser rangefinder according to the present invention, in which: 2—Mode switch; 6—Programmable logic circuit; 7—Clock source; 8—Singlechip; 20—Triode; 21—Resistor; and, 22—Resistor. The operating frequency of the clock source is 100 MHz.

The mainboard circuit for calculating distance and timing sequence of the distance measurement in this embodiment of the present invention has the following major elements: a singlechip P89LPC9401, a programmable logic circuit EPM3032, a 100 MHz active clock-frequency oscillator, a high-speed comparator MAX913 and the like.

The operating principle of the distance measurement is as follows: the laser receiving circuit outputs an echo signal that is reshaped by the high-speed comparator MAX913 to obtain echo pulse; the echo pulse is input to one input end of the programmable logic circuit EPM3032; when it begins to transmit the laser, a clock counting is started by the 100 MHz active clock until the target echo reaches the rangefinder, the counts of the clocks is just the transmission time of the laser, and this time is converted into distance value by the singlechip P89LPC9401 and then displayed. The distance measurement error is ±1 m. The time program for the distance measurement process is controlled by the singlechip for each circuit. The method for distance measurement in the present invention employs direct counting. As the 100 MHz quartz crystal clock has high stability for clock frequency, the generated errors of distance measurement are small, so that the calibration steps of the distance error are simplified.

In FIG. 7, the singlechip 8 is configured to control the timing sequence of the distance measurement, control the power supply and drive the liquid crystal display. The programmable logic circuit 6 and the clock source 7 are configured to perform a time measurement. The time measurement is started with the generated FSctrl signal, and ended with the BACKW signal, i.e., target echo signal. The triode 20 serves to control the power of the programmable logic circuit 6. The control signal is given by the 3VC of the singlechip 8. The mode switch 2 is configured to perform switchover between distance measurement modes (measurement unit, function, etc.). The resistors 21 and 22 serve as the cell-voltage sampler and divider for monitoring the service condition of the cell.

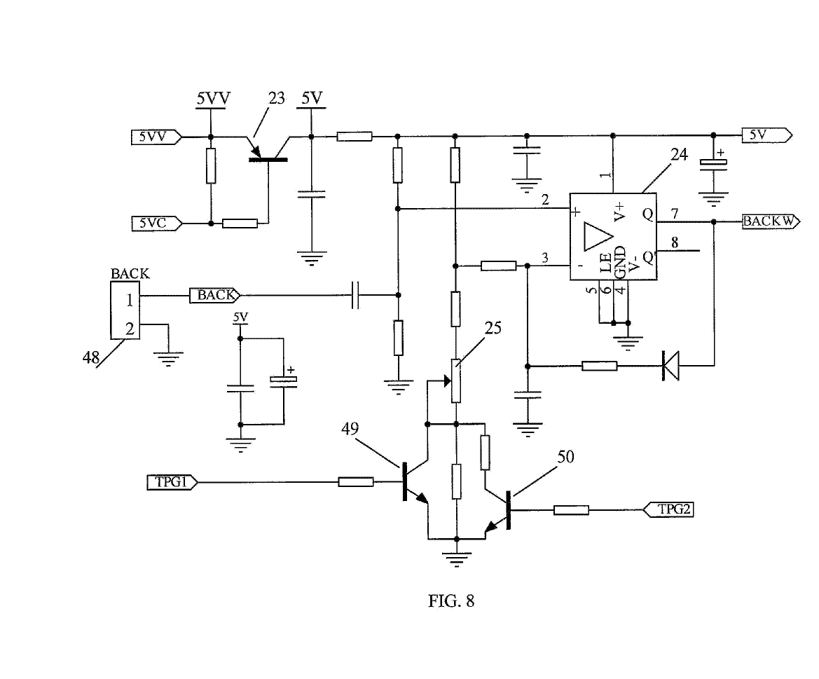

FIG. 8 shows an electrical schematic diagram of a target echo identification circuit of a semiconductor laser rangefinder according to the present invention, in which: 23—Triode; 49—First control triode; 50—Second control triode; 24—High-speed comparator; 25—Variable resistor; and, 48—Socket (the same as that in the receiving circuit).

In FIG. 8, the output signal from the laser receiving circuit includes target echo signal and noise. To select a valid echo signal from the target echo signal and noise, a high-speed and low-noise circuit is required for identification, which is just what the circuit of FIG. 8 executes. The power supply (5V) of the target echo identification circuit is the same as that of the laser receiving circuit. The triode 23 serves as a control tube of the power supply of the target echo identification circuit, with the control signal given by a SVC signal output of the singlechip 8. The high-speed comparator 24 is configured to identify the echo signal from the noise. The input (BACK) of the high-speed comparator is connected to the main circuit board via the socket (48), while the output signal (BACKW) is the reshaped echo pulse. The variable resistor 25 is configured to adjust an identification threshold. Control signals (TPG1, TPG2) for the base of two triodes 49 and 50 at the lower end of the variable resistor 25 are given by the singlechip, with a function of automatically rising the identification threshold for suppressing strong, short-distance echo signals, so that the laser rangefinder can achieve short-distance measurement within 5 m.

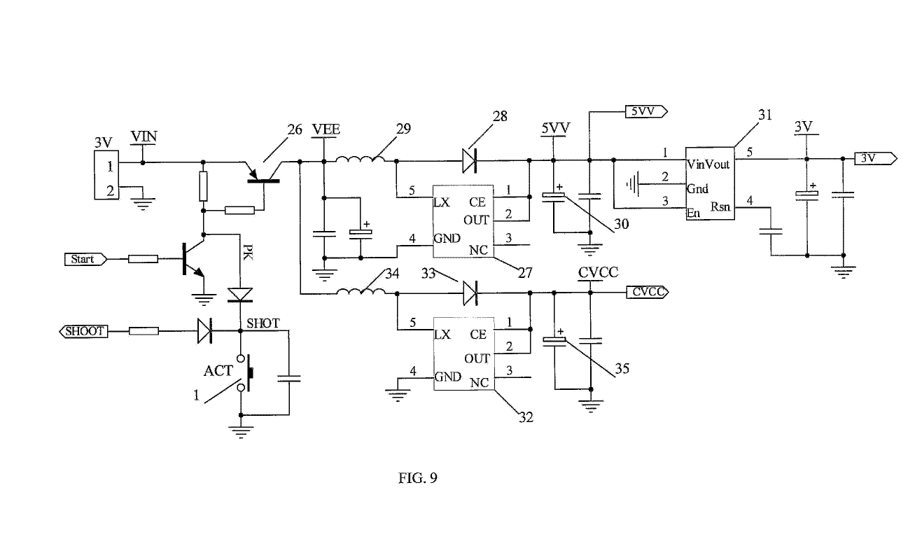

FIG. 9 shows an electrical schematic diagram of a low-voltage power circuit of a semiconductor laser rangefinder according to the present invention, in which: 26—Triode; 27—Intergrated circuit; 28—Diode; 29—Inductor; 30—Capacitor; 31—Three-terminal regulator; 32—Integrated circuit; 33—Diode; 34—Inductor; and, 3-Capacitor.

The triode 26 serves to control the general power supply. When the trigger switch (ACT) is pressed down and soon released, the singlechip is powered on. The singlechip outputs a START signal to keep the triode 26 turned on within a timing time in order to ensure the normal operation of the subsequent power supplies. A DC-DC boost circuit (comprising the integrated circuit 27, the diode 28, the inductor 29, the capacitor 30 and other elements) outputs a 5VV voltage to the singlechip 8. The three-terminal regulator 31 outputs a 3V power to the 100 MHz clock source 7 and the programmable logic circuit 6. A DC-DC boost circuit (comprising the integrated circuit 32, the diode 33, the inductor 34, the capacitor 35 and other elements) outputs a CVCC voltage to the high-voltage power circuit 7. The three-terminal regulator 31 provides a 3V power to the 100 MHz clock source 7 and the programmable logic circuit 6. The power CVC of the programmable logic circuit 6 is controlled by the singlechip. The low-voltage power circuit in the semiconductor laser rangefinder according to the embodiments of the present invention may realize the reverse polarity protection to the cell without additional diode connected in reverse polarity, thus the utilization efficiency of the cell is improved.

Although the exemplary embodiments and advantages thereof have been described herein in details, it should be understood that various variations, substitutions and modifications may be made to those embodiments without departing from the spirit of the present invention and the protection scope defined by the appended claims. It should be pointed out that, for an ordinary person skilled in the art, the invention may have various improvements and embellishments without departing from the principle of the invention, and these improvements and embellishments should also be regarded as falling into the protection scope of the invention.

1. A laser transmitting circuit, comprising an energy storage capacitor, a laser transmitting tube, an MOS switch circuit and an MOS switch driving circuit; wherein,
a low-potential end of the energy storage capacitor is connected to a cathode of the laser transmitting tube, while a high-potential end of the energy storage capacitor is connected to a drain of the MOS switch circuit;
a grounding end of the MOS switch circuit is connected to an anode of the laser transmitting tube; and
an output end of the MOS switch driving circuit is connected to an input end of the MOS switch circuit.

2. The laser transmitting circuit according to claim 1, wherein the MOS switch circuit is controlled by the MOS switch driving circuit by the following steps:
the MOS switch circuit is turned on when the MOS switch driving circuit is triggered, so that the energy storage capacitor discharges to the laser transmitting tube to make the laser transmitting tube generate a pulse laser; or
the MOS switch circuit is turned off when the MOS switch driving circuit has no output, so that a high-voltage power supply charges the energy storage capacitor to get ready for a next laser transmission.

3. The laser transmitting circuit according to claim 1, wherein a time for turning on or off the MOS switch circuit meets the following conditions:
a turn-on time ton≦10 ns, and a turn-off time toff≦22 ns.

4. The laser transmitting circuit according to claim 1, wherein a pulse current of the MOS switch circuit meets the following condition:
the pulse current Ip≧100 A.

5. A laser receiving circuit, comprising a laser receiving tube, a first low-noise triode, a second low-noise triode and a low-noise wideband amplifier, wherein,
an anode of the laser receiving tube is connected to a base of the first low-noise triode;
an emitter of the first low-noise triode is connected to a base of the second low-noise triode;
a collector of the second low-noise triode is connected to an input end of the low-noise wideband amplifier via a capacitor; and
when the laser receiving tube receives an echo laser, the echo laser is converted into an electric pulse; and the electric pulse in turn passes through a pre-amplifier consisting of the first low-noise triode and the second low-noise triode, and then a post-amplifier of the low-noise wideband amplifier, to generate and output an echo signal.

6. The laser receiving circuit according to claim 5, wherein the first low-noise triode and the second low-noise triode form a low-noise pre-amplifier, and a maximum voltage amplification factor of the post-amplifier of the low-noise wideband amplifier can reach 400 times and may be adjustable; wherein, a wideband of the low-noise wideband amplifier is not less than 50 MHz, which meets the requirement of a 0.1 m rangefinder in measurement precision.

7. The laser receiving circuit according to claim 6, wherein the laser receiving circuit is particularly applicable to PIN photodiodes.

8. A circuit for calculating distance, comprising a singlechip, a programmable logic circuit, a clock source and an echo identification circuit,
wherein, an output end of the echo identification circuit is connected to an input end of the programmable logic circuit, an output end of the clock source is connected to an input end of the programmable logic circuit, and an output end of the programmable logic circuit is connected to an input end of the singlechip;
the echo identification circuit is configured to identify a signal from a laser receiving circuit including a target echo signal and noise, and to realize echo detection in a minimum distance not longer than 5 m by controlling a threshold of the echo identification circuit;
the programmable logic circuit is configured to receive an echo pulse and perform a time measurement to the echo pulse according to a signal from the clock source; and
the singlechip is configured to control the programmable logic circuit and calculate a distance from a target according to information about the time measurement provided by the programmable logic circuit.

9. The circuit for calculating distance according to claim 8, wherein a 100 MHz, active, quartz crystal oscillator is used as the clock source.

10. A semiconductor laser rangefinder, comprising devices of any circuit according to claim 1.

11. A semiconductor laser rangefinder, comprising devices of any circuit according to claim 5.

12. A semiconductor laser rangefinder, comprising devices of any circuit according to claim 8.
